(19) United States
(12) Patent Application Publication
(10) Pub. No.: US 2018/0074955 A1
(43) Pub. Date: Mar. 15, 2018

(54) TIME DE-INTERLEAVING CIRCUIT AND TIME DE-INTERLEAVING METHOD

(71) Applicant: MStar Semiconductor, Inc., Hsinchu Hsien (TW)

(72) Inventor: CHUN-CHIEH WANG, Hsinchu County (TW)

(21) Appl. No.: 15/486,394

(22) Filed: Apr. 13, 2017

(30) Foreign Application Priority Data
Sep. 12, 2016 (TW) 105129531

(51) Int. Cl. G06F 12/06; H04N 21/232

(52) U.S. Cl. CPC G06F 12/0646; G06F 2212/174; G06F 2212/1024; H04N 21/2326

(57) ABSTRACT

A time de-interleaving circuit is located at a signal receiver of a communication system to perform a time de-interleaving process on an interleaved signal. The interleaved signal includes a plurality of information units, which include a plurality of data units and a plurality of common units. The time de-interleaving circuit includes: a data unit access address generator, generating a plurality of data unit access addresses according to a first address sequence to accordingly access the plurality of data units in a memory; and a common unit access address generator, generating a plurality of common unit access addresses according to a second address sequence to accordingly access the plurality of common units in the memory. The second address sequence is a reverse sequence of the first address sequence.

This application claims the benefit of Taiwan application Serial No. 105129531, filed Sep. 12, 2016, the subject matter of which is incorporated herein by reference.

### BACKGROUND OF THE INVENTION

### Field of the Invention

The invention relates in general to a time de-interleaving circuit and method, and more particularly to a time de-interleaving circuit and method capable of preventing information units from being inappropriately overwritten.

### Description of the Related Art

In general, before a Digital Video Broadcasting—Second Generation Terrestrial (DVB-T2) broadcast signal is transmitted, cell interleaving and time interleaving processes are performed on data to be transmitted to minimize effects that various types of interference has on transmitted data, so that the receiver may obtain correct transmitted data. After the signal is received at the receiver, time de-interleaving and cell de-interleaving processes are performed on the received signal to correctly decode the data.

In addition to adopting time de-interleaving to improve the resistance against impulsive interference, DVB-T2 also enhances channel transmission capabilities to satisfy transmission bandwidth requirements of high-definition resolution images and three-dimensional images. Meanwhile, DVB-T2 adopts a physical layer pipe (PLP) technology to provide flexibilities for different commercial modes, so as to further provide service-oriented response capabilities.

When a DVB-T2 receiver uses multiple PLPs, a part of received signals of the receiver provide data to individual PLPs (to be referred to as data PLP, formed by a plurality of information units), whereas another part provides data to all PLPs (to be referred to as common PLP, formed by a plurality of information units), e.g., center frequencies, single frequency network/multiple input single output (SFN/MISO) parameters and bandwidths. Conventional technologies may use following methods to access data PLP and common PLP.

In the first method, data PLP and common PLP are individually accessed using non-shared (i.e., separate) memory spaces. Although this method prevents access processes of data PLP and common PLP from interfering each other, sufficient spaces need to be individually provided for data PLP and common PLP. For example, a memory space having a capacity prepared for writing and reading data PLP of each PLP is 2×Memory_{data}_{_}ₘₐₓ (e.g., a storage space having 2×(2¹⁹+2¹⁵) information units), and a memory space having a capacity prepared for writing and reading common PLP of each PLP is 2×Memory_{common}_{_}ₘₐₓ (e.g., a storage space having 2×2¹⁶) information units. However, because the data size of each set of data PLP and the data size of each set of common PLP usually do not reach their maximum, particularly do not simultaneously reach their maximum, a part in each of the storage spaces of data PLP and common PLP is usually idle and wasted.

In the second method, data PLP and common PLP are accessed by using a shared memory space through ping-pong buffering. As shown from FIG. 1a to FIG. 1d, a first part 110 and a second part 120 of a memory space 100 are provided for accessing data PLP and common PLP of one PLP. When the first part 110 is used for writing data PLP, the second part 120 is used for reading previously written data PLP. Similarly, when the first part 110 is used for writing common PLP, the second part 120 is used for reading previously written common PLP. As the data sizes of data PLP and common PLP may be different, the time needed for accessing the two may also be different. Thus, there are four possible scenarios for the access of data PLP and common PLP as time passes:

(i) As shown in FIG. 1a, the first part 110 is used for writing data PLP and common PLP currently to be written, and the second part 120 is used for reading previously written data PLP and common PLP.

(ii) As shown in FIG. 1b, the first part 110 is used for reading data PLP and common PLP, and the second part is used for writing data PLP and common PLP.

(iii) As shown in FIG. 1c, the first part 110 is used for reading data PLP and writing common PLP, and the second part 120 is used for writing data PLP and reading common PLP.

(iv) As shown in FIG. 1d, the first part 110 is used for writing data PLP and reading common PLP, and the second part 120 is used for reading data PLP and writing common PLP.

Known from FIG. 1a to FIG. 1d, a current technology accesses data PLP and common PLP according to a sequence of memory addresses (i.e., an access starting address of common PLP directly follows an access ending address of data PLP), and so the sequences of addresses used in the memory space are continuous. However, the data sizes of two successive sets of data PLP may not be equal. If the data size of a next set of data PLP is larger than the data size of a previous set of data PLP, the data of the next set of data PLP overwrites common PLP that is not yet read out when the next set of data PLP is written. As shown in FIG. 1e, this occurrence may result in lost data.

It is known from the above description that, when handling access of data PLP and common PLP, current technologies result in issues of either memory space waste or overwriting data that is not yet read out.

### SUMMARY OF THE INVENTION

The invention is directed to a time de-interleaving circuit and a time de-interleaving method to reduce the memory capacity that a time de-interleaving process requires and to prevent data from being inappropriately overwritten.

The present invention discloses a time de-interleaving circuit located at a signal receiver of a communication system to perform a time de-interleaving process on an interleaved signal. The interleave signal includes a plurality of information units, which include a plurality of data units and a plurality of common units. According to an embodiment, the time de-interleaving circuit includes: a data unit access address generator, generating a plurality of data unit access addresses according to a first address sequence to accordingly access the data units in a memory; and a common unit access address generator, generating a plurality of common unit access addresses according to a second address sequence to accordingly access the common units in the memory. The first address sequence is a reverse sequence of the first address sequence.

The present invention further discloses a time de-interleaving method applied to a signal receiver of a communication system to perform a time de-interleaving process on an interleaved signal. The interleaved signal includes a plurality of information units, which include a plurality of data units and a plurality of common units. According to an embodiment, the method includes: generating a plurality of data unit access addresses according to a first sequence; generating a plurality of common unit access addresses according to a second address sequence, wherein a change trend between two adjacent addresses among the common unit access addresses is different from a change trend between two adjacent addresses among the data unit access address; and accessing the data units in a memory according to the data unit access addresses, and accessing the common units in the memory according to the common unit access addresses.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1a to FIG. 1e are schematic diagrams of a conventional technology accessing non-shared data (data PLP) and shared data (common PLP) of a PLP;

FIG. 2 is a block diagram of a time de-interleaving circuit according to an embodiment of the present invention;

FIG. 3 is a detailed block diagram of the time de-interleaving circuit in FIG. 2;

FIG. 4 is a schematic diagram of a memory in FIG. 2;

FIG. 5 is a block diagram of a time de-interleaving circuit according to another embodiment of the present invention; and

FIG. 6 is a flowchart of a time de-interleaving method according to an embodiment of the present invention.

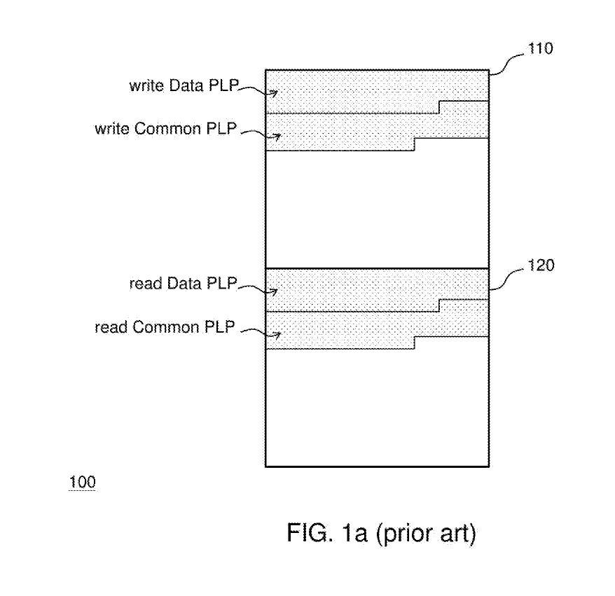

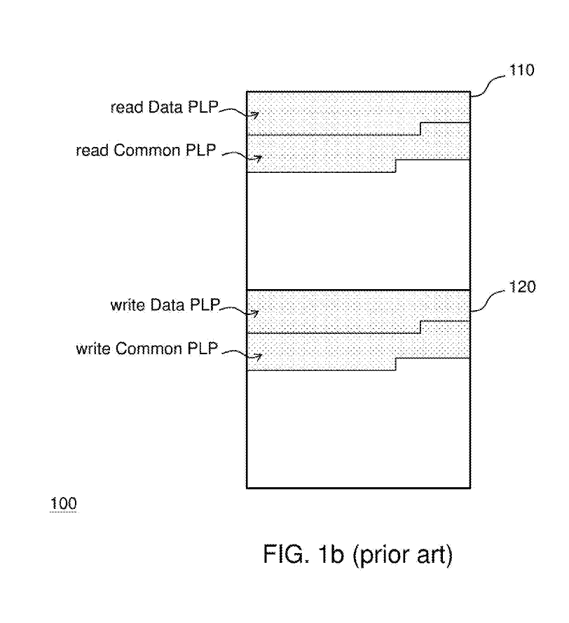

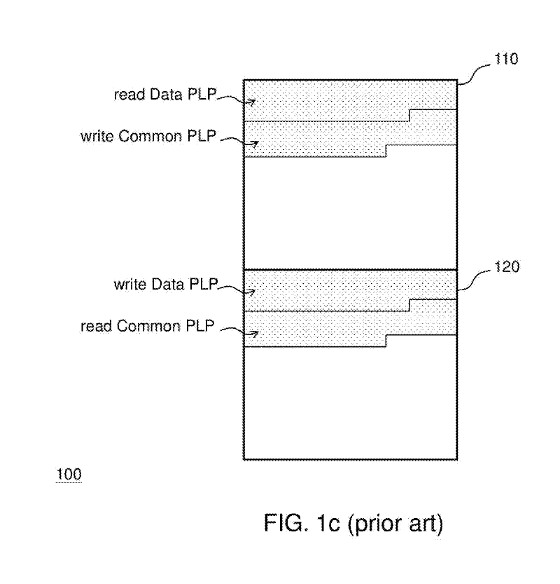

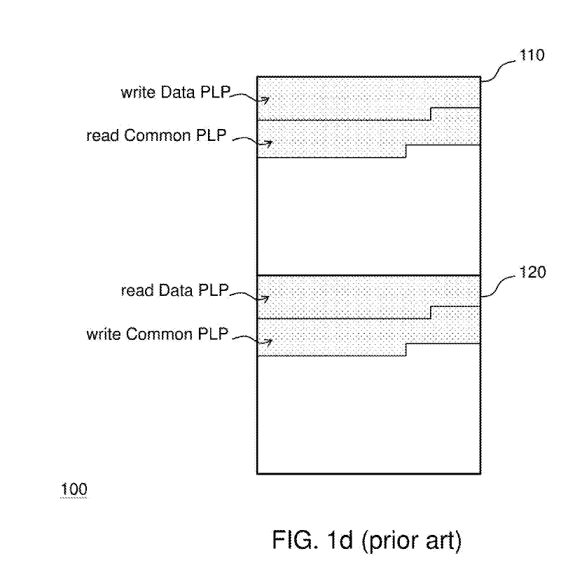

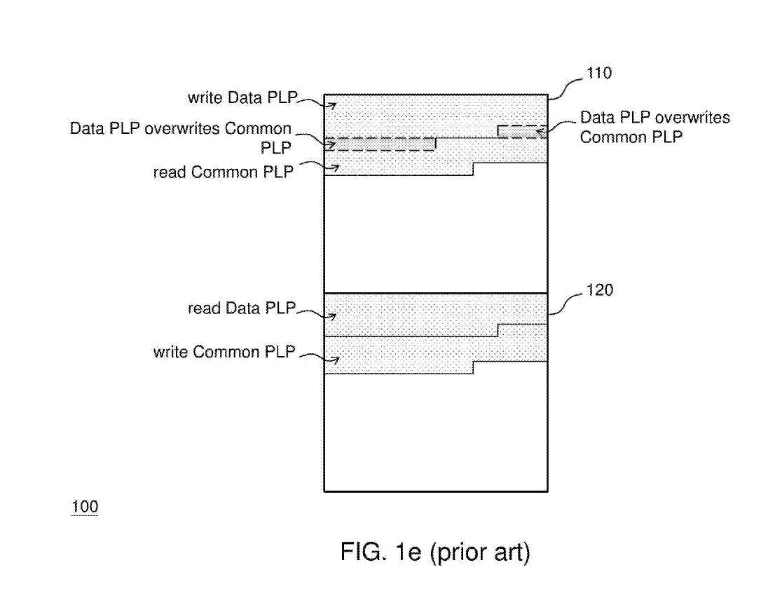

### DETAILED DESCRIPTION OF THE INVENTION

The present invention discloses a time de-interleaving circuit and a time de-interleaving method capable of reducing the memory capacity that a time de-interleaving process requires and preventing data from being inappropriately overwritten.

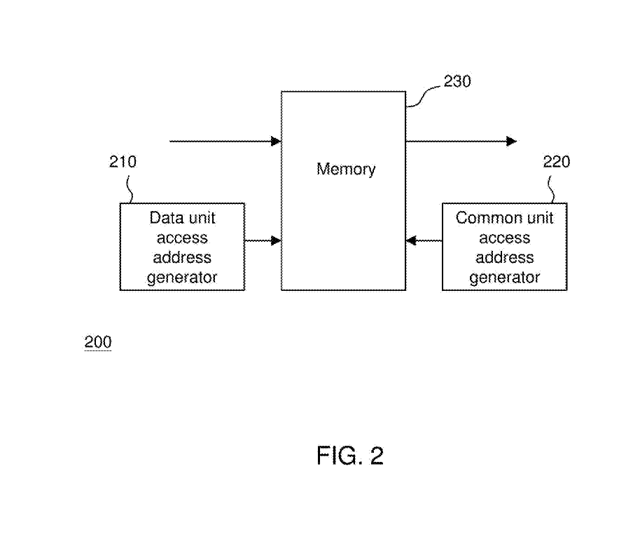

FIG. 2 shows a block diagram of a time de-interleaving circuit according to an embodiment of the present invention. The time de-interleaving circuit 200 in FIG. 2 is located at a signal receiver of a communication system, and is used to perform a time de-interleaving process on an interleaved signal. The interleaved signal includes a plurality of information units, which includes a plurality of data units (or referred to as data PLP) provided for the PLP and a plurality of common units (or referred to as common PLP) provided for the PLP. The time de-interleaving circuit 200 includes a data unit access address generator 210, a common unit access address generator 220 and a memory 230. The definitions of the data units and common units may be referred from the description of the prior art in the application.

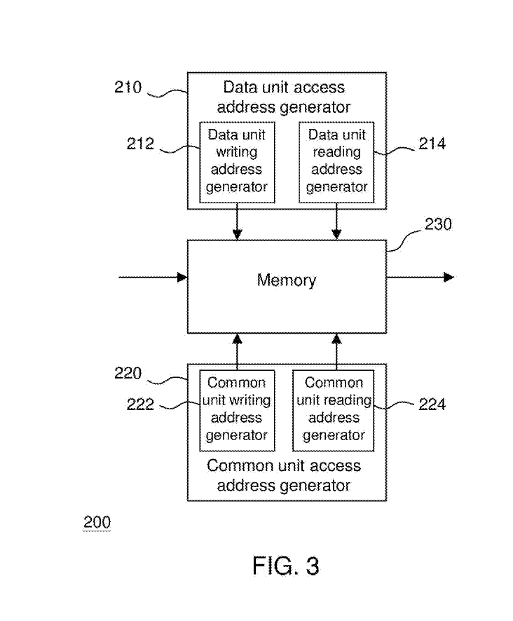

The data unit access generator 210 generates a plurality of data unit access addresses according to a first address sequence. For example, the first address sequence is an address incremental/decremental sequence, which may adopt a successive address incremental/decremental rule or other rule defined by a designer implementing the present invention as the address incremental/decremental rule. Once the first address sequence is determined, one person skilled in the art may design and provide the data unit access address generator 210 based on the disclosure of the present invention. Referring to FIG. 3 showing a block diagram of the data unit access address generator 210 according to an embodiment of the present invention, the data unit access address generator 210 includes a data unit writing address generator 212 that generates a plurality of data unit writing addresses of the data unit access addresses, and a data unit reading address generator 214 that generates a plurality of data unit reading addresses of the data unit access addresses.

The common unit access generator 220 generates a plurality of common unit access addresses according to a second address sequence. The second address sequence is a reverse sequence of the first address sequence, and may adopt a successive address decremental/incremental rule or other rule defined by a designer implementing the present invention as the address decremental/incremental rule. Similarly, once the second address sequence is determined, one person skilled in the art may design and provide the common unit access address generator 220 based on the disclosure of the present invention. Referring to FIG. 3 showing the common unit access address generator 220 according to an embodiment of the present invention, the common unit access address generator 220 includes a common unit writing address generator 222 that generates a plurality of common unit writing addresses of the common unit access addresses, and a common unit reading address generator 224 that generates a plurality of common unit reading addresses of the common unit access address.

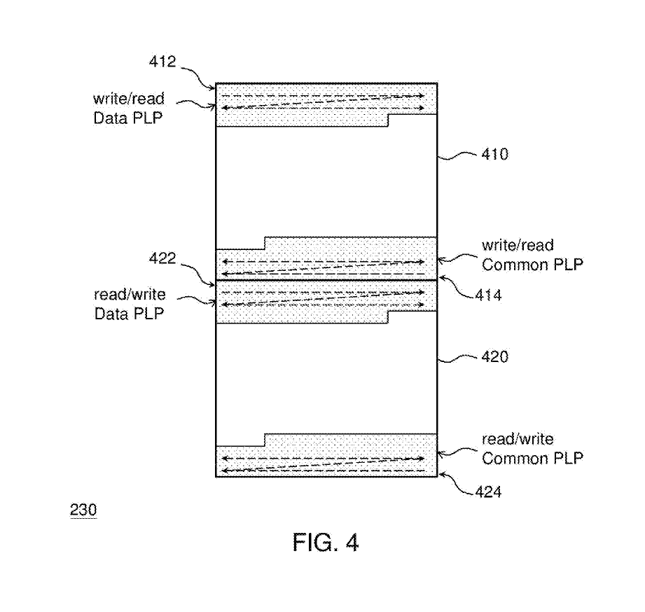

The memory 230 accesses the data units of the information units according to the data unit access addresses, and accesses the common units of the information units according to the common unit access addresses. For example, as shown in FIG. 4, the memory 230 includes a first-part memory 410 and a second-part memory 420. The storage capacity of the first-part memory 410 is determined by a first starting position 412 and a first ending position 414, and the storage capacity of the second-part memory 420 is determined by a second starting address 422 and a second ending address 424. When the first-part memory 410 is used for one of writing and reading operations of data units, the second-part memory 420 is used for the other; when the first-part memory 410 is used for one of writing and reading operations of common units, the second-part memory 420 is used for the other.

Referring to FIG. 3 and FIG. 4, assume that the first address sequence is one of an address incremental sequence and an address decremental sequence, and the second address sequence is the other. Accordingly, in a K^{th} access operation, the data unit writing address generator 212 generates a plurality of data unit writing addresses according to a first address (e.g., the first starting address 412) and the first address sequence, and the data unit reading address generator 214 generates a plurality of data unit reading addresses according to a second address (e.g., the second starting address 422) and the first address sequence. Further, the data unit writing address generator 212 and/or the data unit reading address generator 214 generate(s) the data unit writing addresses and/or the data unit reading addresses further according to a time interleaving rule corresponding to the data units, such that the time de-interleaving process performed on the data units is completed after the data units are read from/written to the memory 230. In the K^{th} access operation, the common unit writing address generator 222 generates a plurality of common unit writing addresses according to a third address (e.g., the first ending address 414) and the second address sequence, and the common unit reading address generator 224 generates a plurality of common unit reading addresses according to a fourth address (e.g., the second ending address 424) and the second address sequence. Similarly, the common unit writing address generator 222 and/or the common unit reading address generator 224 generates the common unit writing addresses and/or the common unit reading addresses further according to the time interleaving rule corresponding to the common units, such that the time de-interleaving process performed on the common units is completed after the common units are read from/written to the memory 230. The first, second, third and fourth addresses are different, and K is a positive integer. Further, in a (K+1)^{th} access operation, the data unit reading address generator 214 generates a plurality of data unit reading addresses according to the first address and the first address sequence, and the data unit writing address generator 212 generates a plurality of data unit writing addresses according to the second address and the first address sequence. In the (K+1)^{th} access operation, the common unit reading address generator 224 generates a plurality of common unit reading addresses according to the third address and the second address sequence, and the common unit writing address generator 222 generates a plurality of common unit writing addresses according to the fourth address and the second address sequence. In brief, the data unit access address generator 210 accesses the data units from the first and second addresses (e.g., both being starting addresses) of the first and second memories 410 and 420, respectively, and the common unit access address generator 220 accesses the common units from the third and fourth addresses (e.g., both being ending addresses) of the first and second memories 410 and 420. Based on the appropriately arrangement of the first, second, third and fourth addresses as well as the opposite setting of the first and second address sequences, the writing process of data units does not overwrite common units to be read out, and vice versa. It should be noted that, each of the first, second, third and fourth addresses is not limited to being one of the starting and ending addresses, given that a sufficient number of buffering addresses between the first and third address and a sufficient number of buffering addresses between the second and fourth addresses are available. It should be noted that, the dotted arrows in FIG. 4 indicate the writing or reading sequence.

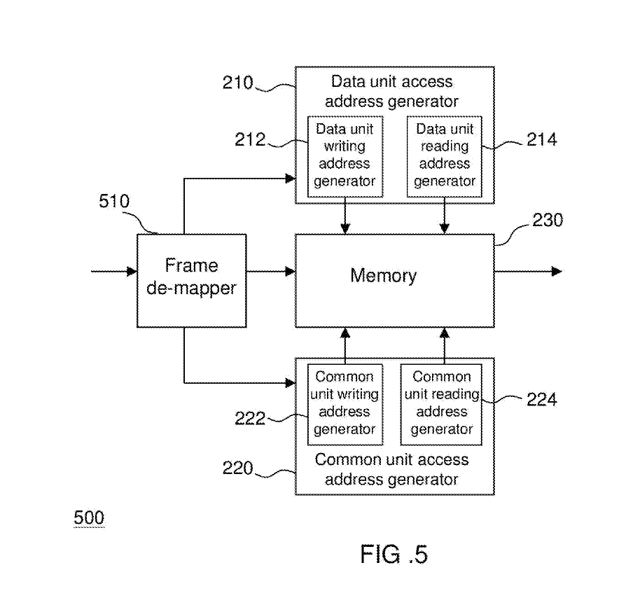

FIG. 5 shows a block diagram of a time de-interleaving circuit according to another embodiment of the present invention. One difference of the time de-interleaving circuit 500 in FIG. 5 from the time de-interleaving circuit 200 in FIG. 3 is that, the circuit 500 further includes a frame de-mapper 510. The frame de-mapper 510 determines whether each unit is a data unit or a common unit, and accordingly generates a data unit flag (or referred to as a data PLP flag) corresponding to the data unit or a common unit flag (or referred to as a common PLP flag) corresponding to the common unit. The data unit access address generator 210 generates a data unit access address for the memory 230 according to the data unit flag and the first address sequence, the common unit access address generator 230 generates a common unit access address to the memory 230 according to the common unit flag and the second address sequence, and the memory 230 accesses the data unit according to the data unit access address or the common unit according to the common unit access address. Details of the frame de-mapper 510 and details of handing the flag are generally known art, and are omitted herein.

As demonstrated in the above description, the time de-interleaving circuit of the present invention reduces the amount of memory used for accessing the data units and common units through a shared memory, and eliminates the issue of overwriting between the data units and common units through arrangements of access sequences and addresses of the memory, thereby solving the dilemma in the technical field through a simple and feasible solution.

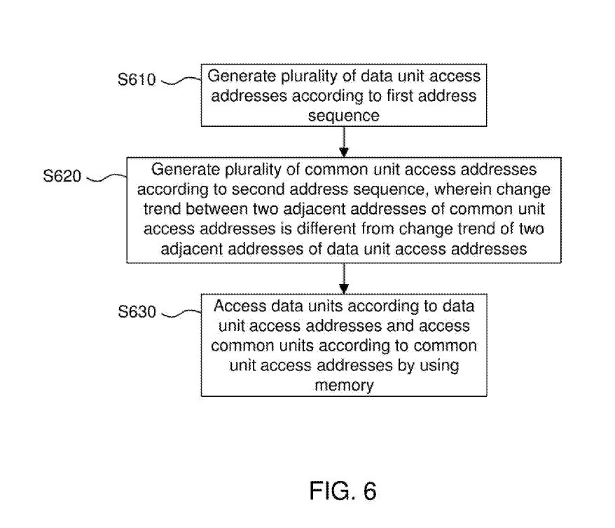

In addition to the foregoing circuit, the present invention further discloses a time de-interleaving method applied to a signal receiver of a communication system to perform a time de-interleaving process on an interleaved signal. The interleaved signal includes a plurality of information units, which include a plurality of data units and a plurality of common units. Referring to FIG. 6, the method according to an embodiment of the present invention includes following steps.

In step S610, a plurality of data unit access addresses are generated according to a first address sequence. This step may be performed by the data unit access address generator 210 in FIG. 2 or its equivalence.

In step S620, a plurality of common unit access addresses are generated according to a second address sequence. A change trend between two adjacent addresses of the common unit access addresses is different from a change trend between two adjacent addresses of the data unit access addresses. For example, the change trend is a difference between a latter address and a former address of the two adjacent addresses. This step may be performed by the common unit access address generator 220 in FIG. 2 or its equivalence.

In step S630, the data units are read from or written to a memory according to the data unit access addresses, and the common units are read from or written to the memory according to the common unit access addresses. For example, the memory is the memory 230 in FIG. 2 or its equivalence.

One person skilled in the art may understand the implementation details and variations of the method of the present invention based on the disclosure associated with the foregoing circuit of the present invention. That is, the technical features of the foregoing circuit may be reasonably applied in the method of the present invention. Therefore, without affecting the full disclosure and possible implementation of the method of the present invention, such repeated details are omitted herein.

In conclusion, the time de-interleaving circuit and the time de-interleaving method of the present invention are capable of reducing the amount of memory that a time de-interleaving process requires as well as preventing data to be read out from being overwritten, thereby enhance cost-effectiveness and accuracy of the de-interleaving process.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A time de-interleaving circuit, located at a signal receiver of a communication system to perform a time de-interleaving process on a time interleaved signal, the interleaved signal comprising a plurality of information units, the information units comprising a plurality of data units and a plurality of common units, the time de-interleaving circuit comprising:
a data unit access address generator, generating a plurality of data unit access addresses according to a first address sequence to accordingly access the data units in a memory; and
a common unit access address generator, generating a plurality of common unit access addresses according to a second address sequence to accordingly access the common units in the memory, wherein the second address sequence is a reverse sequence of the first address sequence.

2. The time de-interleaving circuit according to claim 1, wherein in a K^{th} access operation, the data unit access address generator generates a plurality of data unit writing addresses according to a first address and the first address sequence and generates a plurality of data unit reading addresses according to a second address and the first address sequence, and the common unit access address generator generates a plurality of common data writing addresses according to a third address and the second address sequence, and generates a plurality of common unit reading addresses according to a fourth address and the second address sequence; the first, second, third and fourth addresses are different, and K is a positive integer.

3. The time de-interleaving circuit according to claim 2, wherein in a (K+1)^{th} access operation, the data unit access address generator generates a plurality of data unit reading addresses according to the first address and the first data sequence, and generates a plurality of data unit writing addresses according to the second address and the first address sequence, and the common unit access address generator generates a plurality of common unit reading addresses according to the third address and the second address sequence, and generates a plurality of common data writing addresses according to the fourth address and the second address sequence.

4. The time de-interleaving circuit according to claim 2, wherein the first address sequence is one of an incremental sequence and a decremental sequence, and the second address sequence is the other of the incremental sequence and the decremental sequence.

5. The time de-interleaving circuit according to claim 2, wherein the memory comprises a first-part memory and a second-part memory, a first starting address of the first-part memory and a second starting address of the second-part memory are the first address and the second address, respectively, one of the third address and fourth addresses is a first ending address of the first-part memory and the other of the third and fourth addresses is a second ending address, the first starting address and the first ending address determine a storage capacity of the first-part memory, and the second starting address and the second ending address determine a storage capacity of the second-part memory.

6. The time de-interleaving circuit according to claim 1, further comprising:
a frame de-mapper, generating a plurality of data unit flags and a plurality of common unit flags according to the interleaved signal;
wherein, the data unit access address generator generates the data unit access addresses according to the data unit flags and the first address sequence, and the common unit access generator generates the common unit access addresses according to the common unit flags and the second address sequence.

7. The time de-interleaving circuit according to claim 1, wherein the data unit access address generator comprises:
a data unit writing address generator, generate a plurality of data unit writing addresses of the data unit access addresses; and
a data unit reading address generator, generating a plurality of data unit reading addresses of the data unit access addresses; and
the common unit access address generator comprises:
a common unit writing address generator, generating a plurality of common unit writing addresses of the common unit access addresses; and
a common unit reading address generator, generating a plurality of common unit reading addresses of the common unit access addresses.

8. A time de-interleaving method, applied to a signal receiver of a communication system to perform a time de-interleaving process on an interleaved signal comprising a plurality of information units, the information units comprising a plurality of data units and a plurality of common units, the method comprising:
generating a plurality of data unit access addresses according to a first address sequence;
generating a plurality of common unit access addresses according to a second address sequence, wherein a change trend between two adjacent addresses among the common unit access addresses is different from a change trend between two adjacent addresses among the data unit access addresses; and
accessing the data units in a memory according to the data unit access addresses, and accessing the common units in the memory according to the common unit access addresses.

9. The time de-interleaving method according to claim 8, wherein the step of generating the data unit access addresses comprises:
in a K^{th} access operation, generating a plurality of data unit writing addresses according to a first address and the first address sequence, and generating a plurality of data unit reading addresses according to a second address and the first address sequence; and
the step of generating the common unit access addresses comprises:
in the K^{th} access operation, generating a plurality of common data writing addresses according to a third address and the second address sequence, and generating a plurality of common unit reading addresses according to a fourth address and the second address sequence;
wherein, the first, second, third and fourth addresses are different, and K is a positive integer.

10. The time de-interleaving method according to claim 9, wherein the step of generating the data unit access addresses comprises:
in a (K+1)^{th} access operation, generating a plurality of data unit reading addresses according to the first address and the first data sequence, and generating a plurality of data unit writing addresses according to the second address and the first address sequence; and
the step of generating the common unit access addresses comprises:
in the (K+1)^{th} access operation, generating a plurality of common unit reading addresses according to the third address and the second address sequence, and generating a plurality of common data writing addresses according to the fourth address and the second address sequence.

11. The time de-interleaving method according to claim 8, wherein the first address sequence is one of an incremental sequence and a decremental sequence, and the second address sequence is the other of the incremental sequence and the decremental sequence.

12. The time de-interleaving method according to claim 9, wherein the memory comprises a first-part memory and a second-part memory, a first starting address of the first-part memory and a second starting address of the second-part memory are the first address and the second address, respectively, one of the third address and fourth addresses is a first ending address of the first-part memory and the other of the third and fourth addresses is a second ending address of the second-part memory, the first starting address and the first ending address determine a storage capacity of the first-part memory, and the second starting address and the second ending address determine a storage capacity of the second-part memory.

13. The time de-interleaving method according to claim 8, further comprising:
generating a plurality of data unit flags and a plurality of common unit flags according to the interleaved signal;
wherein, the step of generating the data unit access addresses comprises generating the data unit access addresses according to at least a part of the data unit flags and the first address sequence, and the step of generating the common unit access addresses comprises generating the common unit access address according to at least a part of the common unit flags and the second address sequence.
